(19) United States
(12) Patent Application Publication
(10) Pub. No.: US 2006/0050967 A1
(43) Pub. Date: Mar. 9, 2006

(54) Image processing apparatus and program

(75) Inventor: Takashi Ishijima, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/200,190

(22) Filed: Aug. 10, 2005

(30) Foreign Application Priority Data
Sep. 7, 2004 (JP) JP2004-259846

(51) Int. Cl. G06K 9/68

(52) U.S. Cl. 382/219

(57) ABSTRACT

A proofreading support system includes an image input section, an average-density derivation section, and an image comparison section. The average-density derivation section partitions an output sample and a proof into the same number of partitions both longitudinally and laterally, and derives the average density for each block obtained by the partition from output-sample data and proof data. The image comparison section compares the distributions of the average densities within an image between the output sample and the proof, and based on comparison results, outputs information about differences between the output sample and the proof as check results.

### BACKGROUND OF THE INVENTION

1. Field of the Invention

The present invention relates to an image processing apparatus and program for outputting information about differences between a plurality of images.

2. Description of the Background Art

Conventionally, in print proofreading, differences between a plurality of images have been checked. Such checks may be done by visual comparison by the human eye, but to simplify the checks, various kinds of image processing may be used. For example, Japanese Patent Application Laid-open No. 2000-112110 has disclosed a technique using image processing for detecting differences between a first proof of data, and corrected data.

Although the technique disclosed in Japanese Patent Application Laid-open No. 2000-112110 is suitable for detecting minor differences, it is not capable of ignoring minor differences to detect only major differences. Thus, this technique is not applicable in, for example, the case of checking differences between an output sample (comprehensive) where each part is roughly placed, and a proof which is close to the final print. Further, this technique also has the problem that it is not capable of comparing images of different sizes.

### SUMMARY OF THE INVENTION

The present invention is directed to an image processing apparatus for outputting information about differences between a reference image and a to-be-compared image.

According to the present invention, the image processing apparatus includes an average-density derivation section for partitioning the reference image and the to-be-compared image into the same number of partitions both longitudinally and laterally and deriving average densities for respective blocks obtained by the partition from reference image data for the reference image and to-be-compared image data for the to-be-compared image data; and an image comparison section for comparing distributions of the average densities within an image between the reference image and the to-be-compared image, and based on comparison results, outputting information about differences between the reference image and the to-be-compared image.

Since considerably smaller differences than the block size between the reference image and the to-be-compared image will not be detected as differences, it is possible to output information about major differences between the reference image and the to-be-compared image. Further, since the reference image and the to-be-compared image are partitioned into the same number of blocks, it is possible to output information about differences even between the reference image and the to-be-compared image of different sizes.

Preferably, the number of partitions is user-definable.

Since a user can specify the size of differences to be detected, it is possible to detect differences suitable for the properties of the reference image and the to-be-compared image.

Preferably, the image comparison section is capable of making a line comparison of the distributions of the average densities in a direction of line extension between a reference line which is included in a block array of the reference image, and a permissible line group which is included in a block array of the to-be-compared image and which includes a to-be-compared line located in the same position as the reference line. The line comparison is performed for all lines in the reference image to output, on the basis of results of the line comparison for all lines, information about differences between the reference image and the to-be-compared image.

Since minor differences in a direction perpendicular to the direction of line extension between the reference image and the to-be-compared image will not be detected as differences, it is possible to prevent increase in noise detection due to detection of minor differences.

Preferably, the permissible line group is a group of lines whose distances from the to-be-compared line are within an allowable number of blocks specified by a user.

Since a user can specify the degree of mismatch that is not to be detected as a difference, in the direction perpendicular to the direction of line extension between the reference image and the to-be-compared image, it is possible to detect differences suitable for the properties of the reference image and the to-be-compared image.

Preferably, if there is a similarity in the distributions of the average densities in a direction of line extension between the reference line and a line which is generated by connecting pieces of respective lines within the permissible line group, the image comparison section determines that there is a match in the distributions of the average densities in the direction of line extension between the reference line and the to-be-compared line.

Even in the case where the reference line includes a plurality of parts which, when compared between the reference image and the to-be-compared image, deviate differently with respect to a direction perpendicular to the direction of line extension, it is possible to output appropriate information about major differences between the reference image and the to-be-compared image.

Preferably, the image processing apparatus further includes an image input section for reading an image to generate image data for the image. The image input section generates at least either the reference image data or the to-be-compared image data.

Since the image input section generates from an image, image data for that image, even if the image is not previously in the form of image data, it is possible to output information about differences.

The present invention is also directed to an image processing program.

It is therefore an object of the present invention to provide an image processing apparatus and program which are capable of detecting major differences, and also capable of making a comparison between images of different sizes.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the hardware structure of proofreading support systems according to first and second preferred embodiments of the present invention;

FIG. 2 is a block diagram schematically showing the functional structure of the proofreading support system according to the first preferred embodiment of the present invention;

FIGS. 3A and 3B schematically show an output sample and a proof, respectively, which are equally partitioned into blocks with M rows and N columns;

FIG. 4A is a graph showing a density distribution for a reference line, and FIGS. 4B, 4C, and 4D are graphs each showing a density distribution for each line within a permissible line group;

FIG. 5 illustrates an output-sample input screen;

FIG. 6 illustrates a proof input screen;

FIG. 7 illustrates a number-of-partitions specification screen;

FIG. 8 illustrates an allowable-number-of-blocks specification screen;

FIG. 9 illustrates a check-result output screen (mismatch screen);

FIG. 10 illustrates a check-result output screen (match screen);

FIG. 11 is a flowchart showing a flow of the overall operation of the proofreading support system according to the first preferred embodiment of the present invention;

FIG. 12 is a flowchart showing the operation flow of an image input subroutine in the proofreading support system according to the first preferred embodiment of the present invention;

FIG. 13 is a flowchart showing the operation flow of an average-density derivation subroutine in the proofreading support system according to the first preferred embodiment of the present invention;

FIG. 14 is a flowchart showing the operation flow of an image comparison subroutine in the proofreading support system according to the first preferred embodiment of the present invention;

FIGS. 15A and 15B are diagrams for explaining differences of line comparison between the proofreading support systems according to the first and second preferred embodiments of the present invention; and

FIG. 16 is a flowchart showing an image comparison subroutine in the proofreading support system according to the second preferred embodiment of the present invention.

### DESCRIPTION OF THE PREFERRED EMBODIMENTS

### First Preferred Embodiment

<Structure>

Hardware Structure of Proofreading Support System

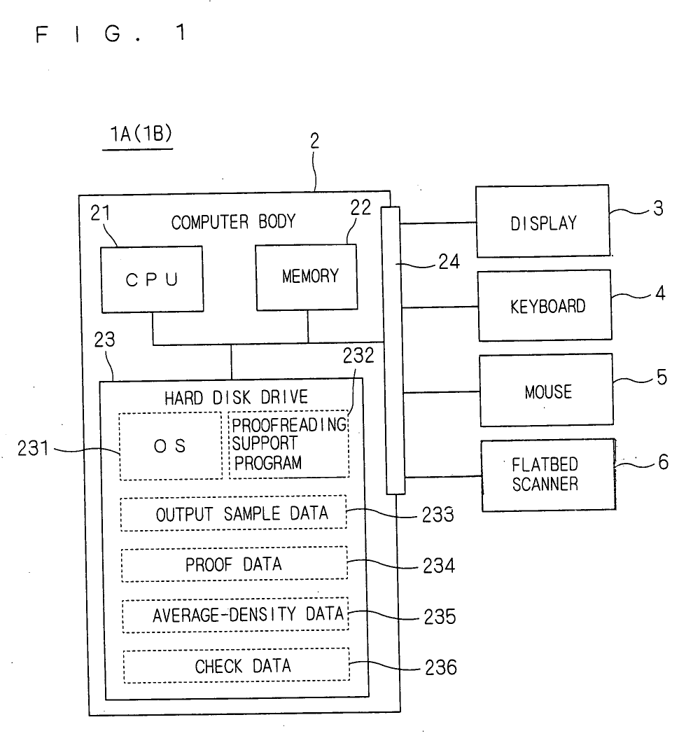

Now, with reference to the block diagram of FIG. 1, we will describe the hardware structure of a proofreading support system 1A according to a first preferred embodiment of the present invention. The proofreading support system 1A is an image processing apparatus which is implemented by execution of a proofreading support program in a personal computer and intended for use to check and output major differences between output samples and proofs in print proofreading.

As shown in FIG. 1, the proofreading support system 1A comprises a computer body 2, a display 3, a keyboard 4, a mouse 5, and a flatbed scanner 6.

The computer body 2 includes a CPU 21 for execution of processing, a memory 22 for temporary storage of execution programs and data, a hard disk drive 23 as a memory, and an I/O interface 24 for connection of external equipment.

The hard disk drive 23 has installed an operating system (OS) 231 which defines the basic operations of a personal computer, and a proofreading support program 232 which causes a personal computer to function as the proofreading support system 1A. The hard disk drive 23 is also storage space for output-sample data 233, proof data 234, average-density data 235, and check data 236, all of which will be described later.

The I/O interface 24 is connected to external equipment such as the display 3, the keyboard 4, the mouse 5, and the flatbed scanner 6.

The display 3 is, for example, a liquid crystal or CRT display. Since the proofreading support system 1A has adopted as a user interface the graphical user interface (GUI), the display 3 displays GUI screens for informing a user of processing results derived from the proofreading support system 1A and for allowing a user to give instructions to the proofreading support system 1A.

The keyboard 4, and the mouse 5 as a pointing device are used for various kinds of GUI operations on GUI screens.

The flatbed scanner 6, in response to a control signal given from the computer body 2, reads an image printed on a document placed on a document placement stage to generate image data for that image. It is of course possible to use other kinds of image input devices, such as a film scanner, a hand scanner, and a digital camera, instead of using the flatbed scanner 6. Such image input devices enable output of information about differences even between output samples and proofs which are not previously in the form of image data.

Functional Structure of Proofreading Support System

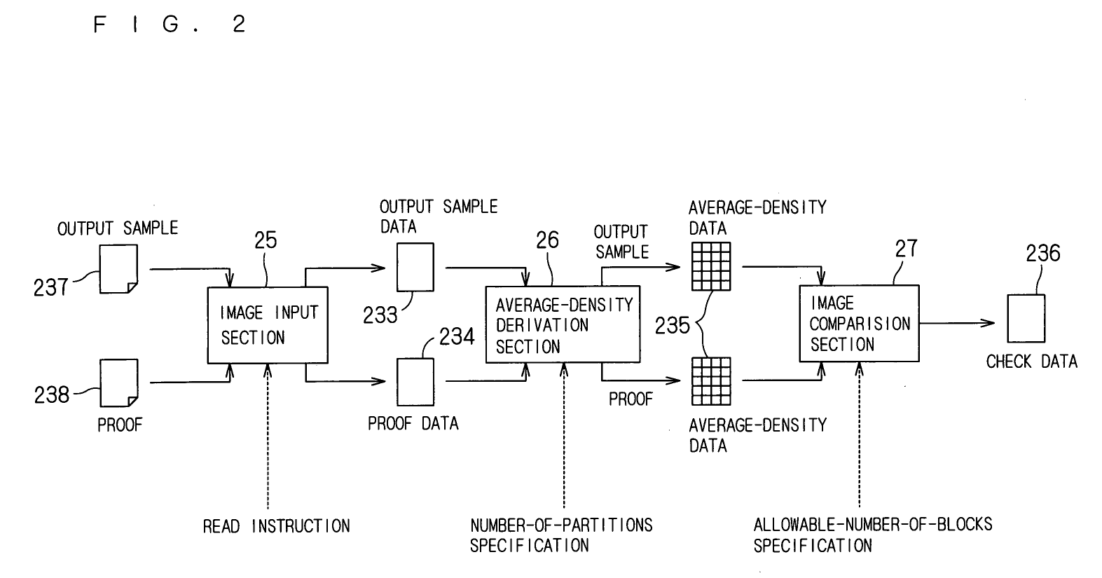

Now, with reference to the block diagram of FIG. 2, we will describe the function of the proofreading support system 1A which is implemented by execution of the proofreading support program 232 in a personal computer. FIG. 2 is a block diagram schematically showing the functional structure of the proofreading support system 1A.

As shown in FIG. 2, the proofreading support system 1A comprises an image input section 25, an average-density derivation section 26, and an image comparison section 27.

The image input section 25 is implemented in the flatbed scanner 6 controlled by the computer body 2 and is intended for use to read an image to generate data for that image. More specifically, the image input section 25, in response to a read instruction from a user, reads an output sample (reference image) 237 and a proof (to-be-compared image) 238 to generate output-sample data (reference image data) 233 for the output sample 237 and proof data (to-be-compared image data) 234 for the proof 238. The generated output-sample data 233 and proof data 234 are stored in the hard disk drive 23. As an alternative, the image input section 25 may generate only either the output-sample data 233 or the proof data 234; for example, the image input section 25 may generate only the output-sample data 233 and the proofreading support system 1A may use data at output (existing image data) as-is as the proof data 234.

The average-density derivation section 26 partitions the output sample 237 and the proof 238 into the same number of blocks both longitudinally and laterally (or specifies pixels included in each block given by the partition), and derives the average density for each block given by the partition from the output-sample data 233 and the proof data 234 stored in the hard disk drive 23. The derived average densities are stored as average density data 235 in the hard disk drive 23. Here, the number of partitions into blocks (hereinafter referred to as the “number of partitions”) is user-definable. Further, the average density, as defined here, is the average value of densities for all pixels included in each block given by the partition and is derived for each color component when the output sample 237 and the proof 238 are color images. While, in the following description, the average density is derived for each of C (cyan), M (magenta), Y (yellow), and K (black) color components, it may be derived for each of R (red), G (green), and B (blue) color components.

The image comparison section 27 compares the distribution of the average densities within an image between the output sample 237 and the proof 238, and based on the comparison results, outputs information about differences between the output sample 237 and the proof 238 as check results. This comparison is made for each of the C, M, Y, and K color components and for each of lines (rows or columns) included in the block array of the output sample 237. Then, based on the comparison results for all the color components and for all the lines, the image comparison section 27 outputs information (check results) about differences between the output sample 237 and the proof 238. The output check results are stored as check data 236 in the hard disk drive 23. Hereinafter, the comparison of a single line included in the block array of the output sample 237 will be referred to as “line comparison.” The details of this line comparison will be described later. Adoption of this comparison technique enables the output of information about major differences between the output sample 237 and the proof 238, because considerably smaller differences than the block size, which may exist between the output sample 237 and the proof 238, will not be detected as differences. Since the number of partitions, i.e., the block size, is user-definable, a user can specify the size of differences to be detected and thus can cause the proofreading support system 1A to detect differences suitable for the properties of the output sample 237 and the proof 238. In other words, for detection of only relatively large differences, a user can set the number of partitions to a small value, and for detection of relatively small differences as well as large ones, a user can set the number of partitions to a large value. Further, since the proofreading support system 1A partitions both the output sample 237 and the proof 238 into a grid with the same number of blocks (matrix partition), it is capable of outputting information about differences even between the output sample 237 and the proof 238 of different sizes. Instead of specifying the number of partitions, a user may specify the size (e.g., longitudinal and lateral lengths) of blocks given by partition of the output sample 237 or the proof 238.

Line Comparison in Image Comparison Section

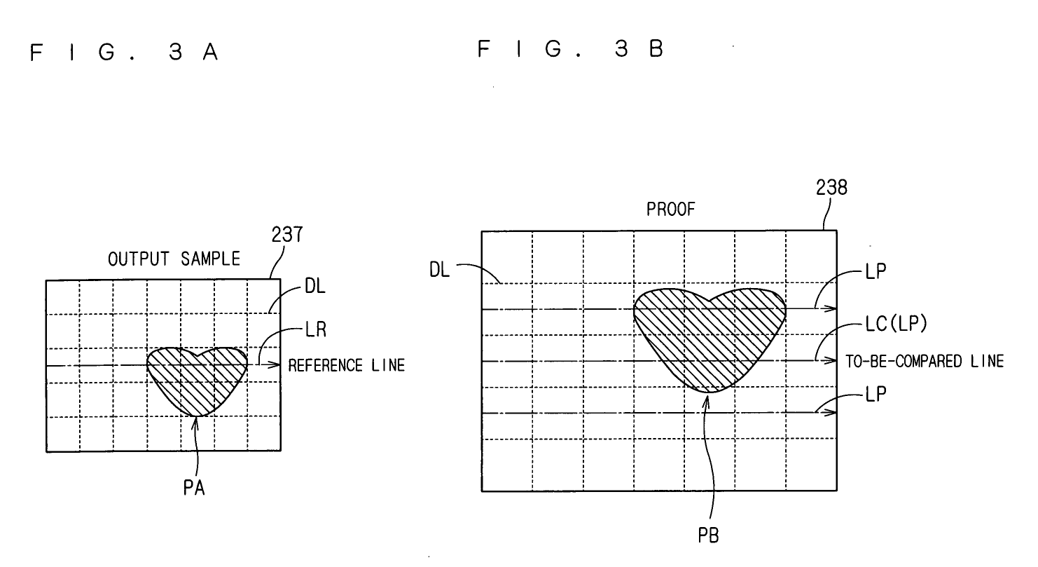

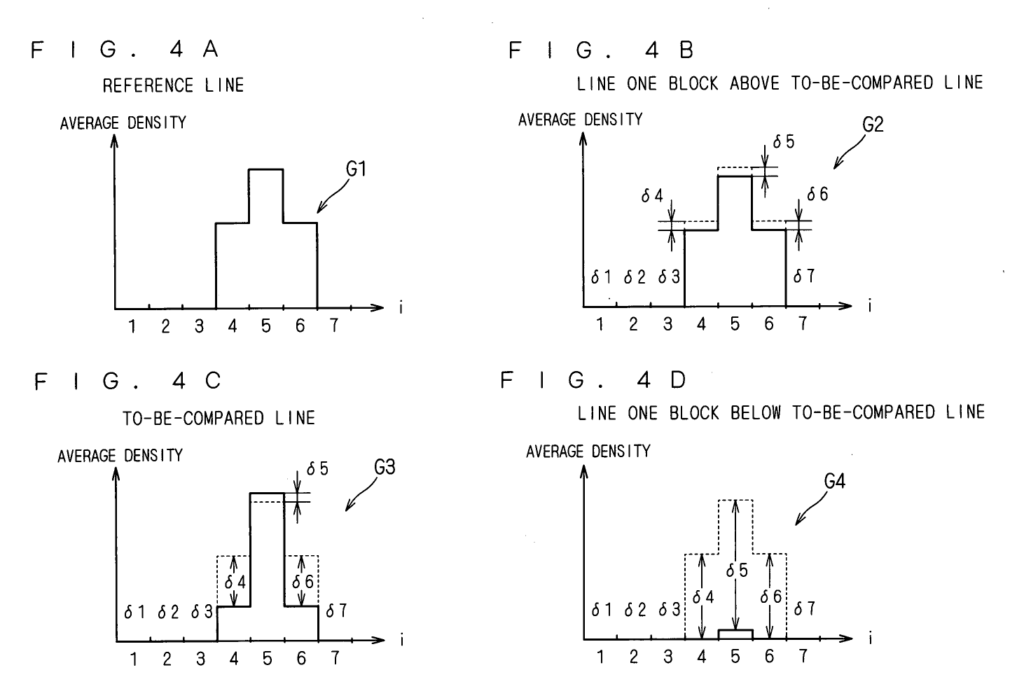

Now, with reference to FIGS. 3A, 3B, and 4A to 4D, the line comparison in the image comparison section 27 will be described.

FIGS. 3A and 3B schematically show the output sample 237 and the proof 238, respectively, which are equally partitioned into blocks with M rows and N columns. As have previously been described, the numbers of horizontal and vertical partitions, M and N, are user-definable. In the example of FIGS. 3A and 3B, M=7 and N=5. While in the example of FIGS. 3A and 3B, the output sample 237 and the proof 238 are of different sizes but have the same aspect ratio, the present invention is also applicable in the case where the output sample 237 and the proof 238 have different aspect ratios. The dotted lines on both the output sample 237 and the proof 238 illustrated in FIGS. 3A and 3B show the boundaries of blocks for the sake of convenience, but the actual output sample 237 and proof 238 do not contain those lines.

Now, an n-th (n=3 in FIG. 3A) line (a straight line of blocks) in the block array of the output sample 237 is focused on and used as a reference line LR for the line comparison. In this case, an n-th line in the block array of the proof 238, which is in the same position as the reference line LR, is a to-be-compared line LC for the line comparison. The proofreading support system 1A can output information about major differences between the output sample 237 and the proof 238 by comparing the distributions of the average densities in the direction of line extension (the horizontal direction in FIGS. 3A and 3B) between the reference line LR and the to-be-compared line LC (hereinafter, the distributions of the average densities in the direction of line extension will be referred to as the “density distribution”). However, in the proofreading support system 1A, in order to prevent increase of noise information due to detection of minor differences, the image comparison section 27 compares the density distributions between the reference line LR and a permissible line group LP consisting of a plurality of lines including the to-be-compared line LC. Here, the permissible line group LP is a group of lines whose distances from the to-be-compared line LC are within an allowable number of blocks Δn specified by a user. FIG. 3B illustrates the case where Δn=1.

Next, the line comparison will be described with reference to a graph G1 (solid line) which shows the density distribution for the reference line LR in FIG. 4A, and graphs G2 to G4 (solid lines) which show the density distributions for respective lines within the permissible line group LP in FIGS. 4B to 4D. In the graphs G1 to G4, the horizontal axis shows an index i that indicates a block position in the direction of line extension, and the vertical axis shows the average density. Here, the index values i of 1, 2, and so on correspond to the positions of a first block, a second block, and so on, respectively. In the graphs G2 to G4, for the sake of comparison, the density distribution for the reference line LR is also shown by the dotted lines. The graphs G2, G3, and G4 show the density distributions for a line which is one block above the to-be-compared line LC, for the to-be-compared line LC, and for a line which is one block below the to-be-compared line LC, respectively.

As shown in the graph G3, it is found by comparison of the output sample 237 and the proof 238 in FIGS. 3A and 3B that the density distribution for the to-be-compared line LC is profoundly different from that for the reference line LR. On the other hand, as shown in the graph G2, the density distribution for the line one block above the to-be-compared line LC is similar to that for the reference line LR. As in this case, if the permissible line group LP contains any line that has a similar density distribution to the reference line LR, the image comparison section 27 determines that there is a match in the density distributions between the reference line LR and the to-be-compared line LC, even though those distributions are actually not similar. On the other hand, only when the permissible line group LP contains no line that has a similar density distribution to the reference line LR, the image comparison section 27 determines that there is a mismatch in the density distributions between the reference line LR and the to-be-compared line LC. Thus, in the case where a part PA (in the output sample 237) and a part PB (in the proof 238) deviate from each other within an allowable number of blocks Δn in a direction perpendicular to the direction of line extension, that deviation can be prevented from being detected as a difference between the output sample 237 and the proof 238. Since the allowable number of blocks Δn is user-definable, a user can determine the degree of mismatch to be detected as a difference in the proofreading support system 1A. Accordingly, a user can allow the proofreading support system 1A to detect differences suitable for the properties of the output sample 237 and the proof 238.

The present invention does not limit the methods for determining a match or mismatch in the density distributions between the reference line LR and respective lines within the permissible line group LP. For example, the determination of a match may be made when all differences (δ1 to δ7 in FIGS. 4B to 4D) in the average densities between blocks in the reference line LR and corresponding blocks in each line within the permissible line group LC are not more than a predetermined threshold value TH1. Further, while in the above description, the reference line LR corresponds to a “row” in the block array, it may be a “column” in the block array, and the line comparison may be performed for both rows and columns.

<User Interface>

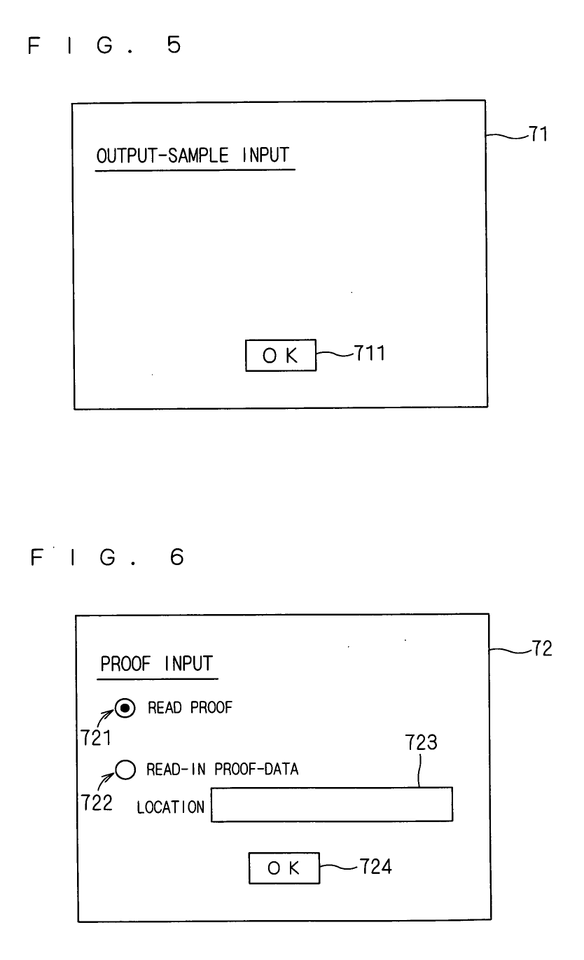

Now, with reference to FIGS. 5 to 10, the GUI screens displayed on the display 3 and user's GUI operations on those GUI screens will be described. FIGS. 5 to 10 illustrate, respectively, an output-sample input screen 71, a proof input screen 72, a number-of-partitions specification screen 73, an allowable-number-of-blocks specification screen 74, a check-result output screen (mismatch screen) 75, and a check-result output screen (match screen) 76.

Output-Sample Input Screen

The output-sample input screen 71, which is initially displayed on the display 3 after activation of the proofreading support program 232, is a screen for prompting the proofreading support system 1A to input the output-sample data 233, i.e., to read the output sample 237. As shown in FIG. 5, the output-sample input screen 71 displays an “OK” button 711 which acts as a trigger for the proofreading support system 1A to read the output sample 237. A user, after placing the output sample 237 on the document placement stage of the flatbed scanner 6, presses the OK button 711 by a GUI operation using the keyboard 4 or the mouse 5 (hereinafter, the “GUI operation using the keyboard 4 or the mouse 5” is simply referred to as the “GUI operation”). In response to this, the proofreading support system 1A outputs a control signal from the computer body 2 to the flatbed scanner 6, whereby the flatbed scanner 6 reads the output sample 237 placed on the document placement stage and stores the generated output-sample data 233 in the hard disk drive 23. Then, the display on the display 3 is switched to the proof input screen 72.

Proof Input Screen

The proof input screen 72 is a screen for prompting the proofreading support system 1A to input the proof data 234, i.e., to read the proof 238 or read in existing image data (image files).

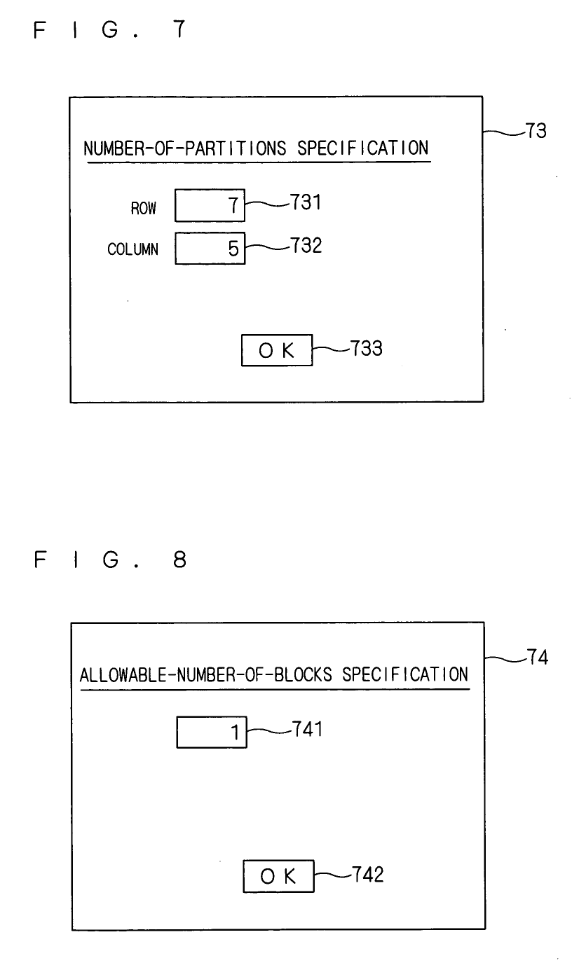

As shown in FIG. 6, the proof input screen 72 displays two alternative radio buttons 721 and 722. On the proof input screen 72, if the radio button 721 is selected, an OK button 724 acts as a trigger to prompt the proofreading support system 1A to read the proof 238. On the other hand, if the radio button 722 is selected, the OK button 724 acts as a trigger to prompt the proofreading support system 1A to read in existing image data. FIG. 6 illustrates the case where the radio button 721 is selected.

Besides, the proof input screen 72 contains an input field 723 for input of a storage location (path) of image data to be read in.

For reading of the proof 238, a user places the proof 238 on the document placement stage of the flatbed scanner 6; selects the radio button 721 by the GUI operation; and presses the OK button 724. In response to this, the proofreading support system 1A outputs a control signal from the computer body 2 to the flatbed scanner 6, whereby the flatbed scanner 6 reads the proof 238 placed on the document placement stage and stores the generated proof data 234 in the hard disk drive 23. Then, the display on the display 3 is switched to the number-of-partitions specification screen 73.

On the other hand, for reading-in of existing image data as the proof data 234, a user selects the radio button 722 by the GUI operation; inputs a path to existing image data in the input field 723 which allows entry upon user's selection of the radio button 722; and presses the OK button 724. In response to this, the proofreading support system 1A stores image data on the path inputted in the input field 723, as the proof data 234 in the hard disk drive 23. Then, the display on the display 3 is switched to the number-of-partitions specification screen 73.

Number-of-Partitions Specification Screen

The number-of-partitions specification screen 73 is a screen for specifying the numbers of horizontal and vertical partitions, M and N, which are provided to the average-density derivation section 26.

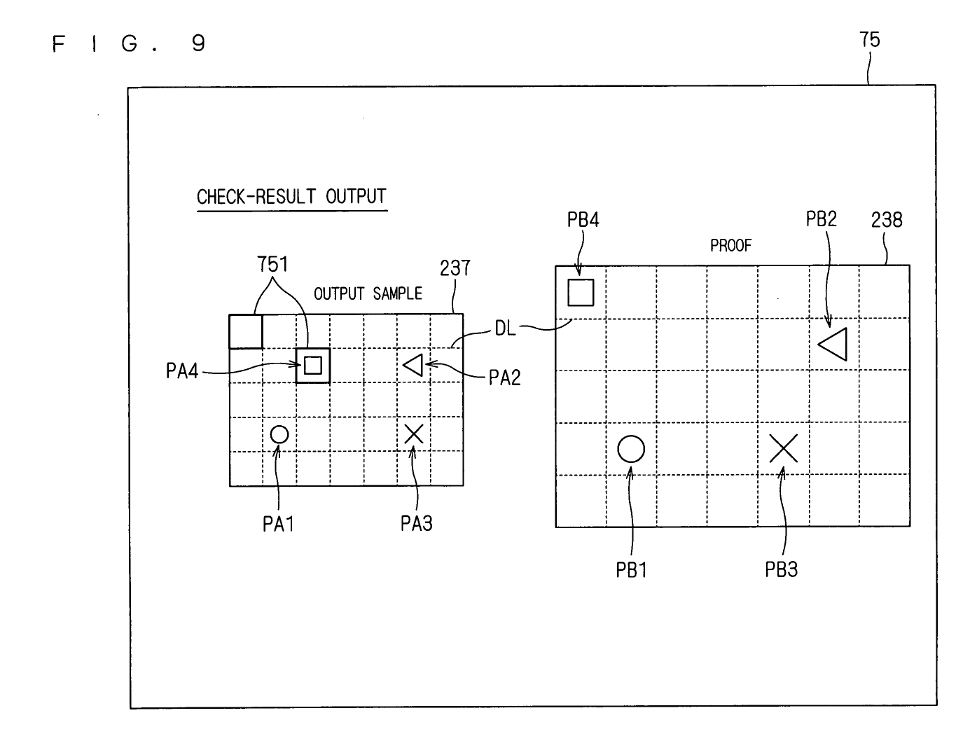

As shown in FIG. 7, the number-of-partitions specification screen 73 displays an input field 731 for input of the number of horizontal partitions M, and an input field 732 for input of the number of vertical partitions N. When a user inputs the numbers of horizontal and vertical partitions, M and N, by the GUI operation and then presses an OK button 733, the proofreading support system 1A gives those numbers M and N to the average-density derivation section 26, in which then average densities are derived. Then, the display on the display 3 is switched to the allowable-number-of-blocks specification screen 74.

Allowable-Number-of-Blocks Specification Screen

The allowable-number-of-blocks specification screen 74 is a screen for specifying the allowable number of blocks Δn which is provided to the image comparison section 27.

As shown in FIG. 8, the allowable-number-of-blocks specification screen 74 displays an input field 741 for input of the allowable number of blocks Δn. When a user inputs the allowable number of blocks Δn by the GUI operation and then presses an OK button 742, the proofreading support system 1A gives the allowable number of blocks Δn to the image comparison section 27, in which then image comparison is made. Then, the display on the display 3 is switched to the check-result output screen 75 or 76.

Check-Result Output Screen

The check-result output screens 75 and 76 are screens for displaying check results outputted from the image comparison section 27 and for a user to recognize the check results. The check-result output screen (mismatch screen) 75 is displayed when there is a mismatch between the output sample 237 and the proof 238, and the check-result output screen (match screen) 76 is displayed when there is a match between the output sample 237 and the proof 238.

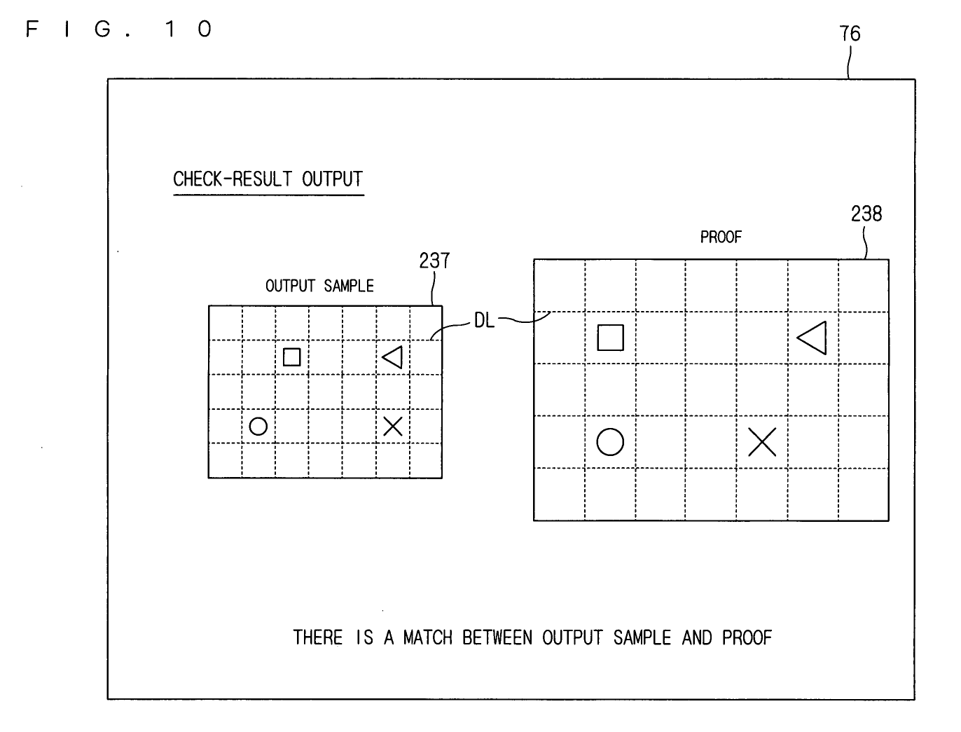

The check-result output screen 75 shown in FIG. 9 displays the output sample 237 and the proof 238. The output sample 237 and the proof 238 on the check-result output screen 75 in FIG. 9 are images including parts PA1 to PA4 and parts PB1 to PB4, respectively. In the proof 238, the blocks including the parts PB1 and PB2 are located in the same positions as the blocks including the corresponding parts PA1 and PA2 in the output sample 237. Further, in the proof 238, the block including the part PB3 is located in a position both longitudinally and laterally within the allowable number of blocks Δn from the block including the corresponding part PA3 in the output sample 237. However, with regard to the block including the part PB4 in the proof 238, its lateral distance from the block including the corresponding part PA4 in the output sample 237 is out of the allowable number of blocks Δn. Here, it is noted that the dotted lines DL in the output sample 237 and the proof 238 in FIG. 9 show the boundaries of blocks for the sake of convenience, but they are not actually displayed on the check-result output screen 75 (or 76).

On the check-result output screen 75, cursors 751 are superimposed and displayed over the areas of the output sample 237 corresponding to the blocks where a mismatch has been detected by the image comparison section 27, so that a user is informed of information about differences between the output sample 237 and the proof 238. Thus, by referring to the check-result output screen 75, a user can recognize differences between the output sample 237 and the proof 238 and thereby can execute appropriate proofreading. Here, since the check-result output screen 75 does not display cursors to indicate minor differences within blocks and within an allowable number of blocks, a user can recognize only major differences without being confused with noise information about minor differences.

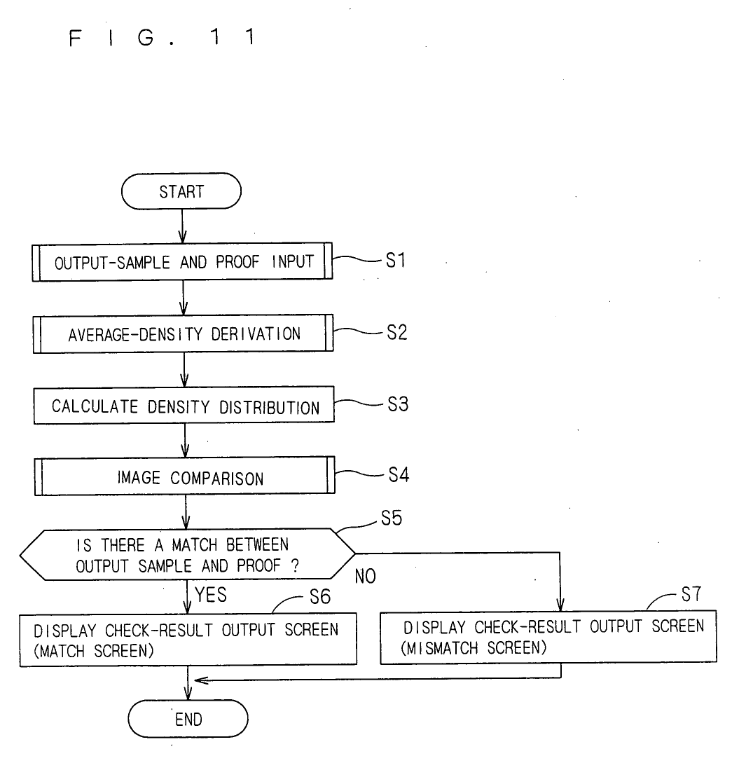

If no mismatch has been detected by the image comparison section 27, no cursor 751 is displayed on the check-result output screen 76 as shown in FIG. 10. Thus, a user can recognize the fact that the output sample 237 and the proof 238 roughly match with each other.

<Operation>

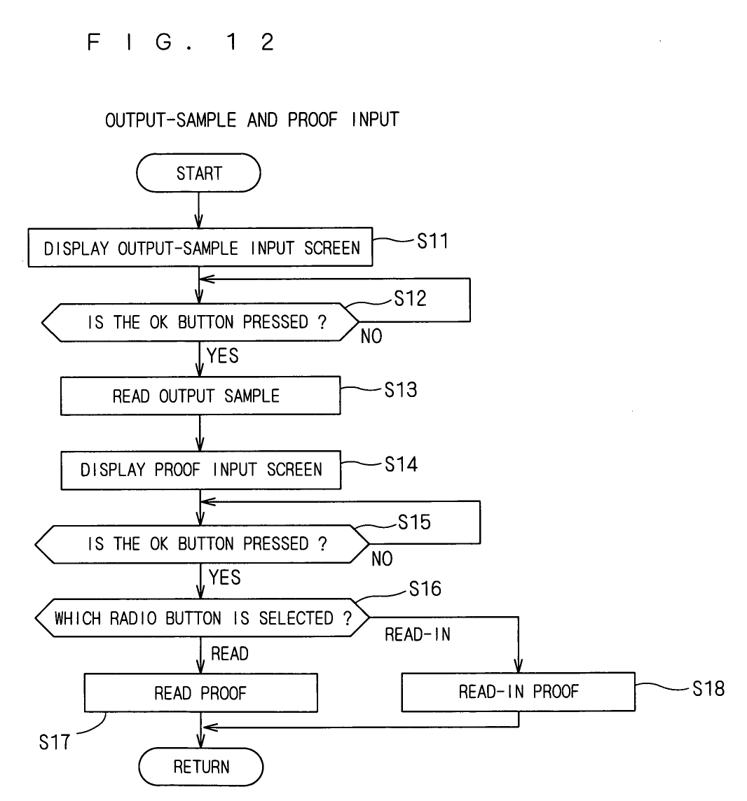

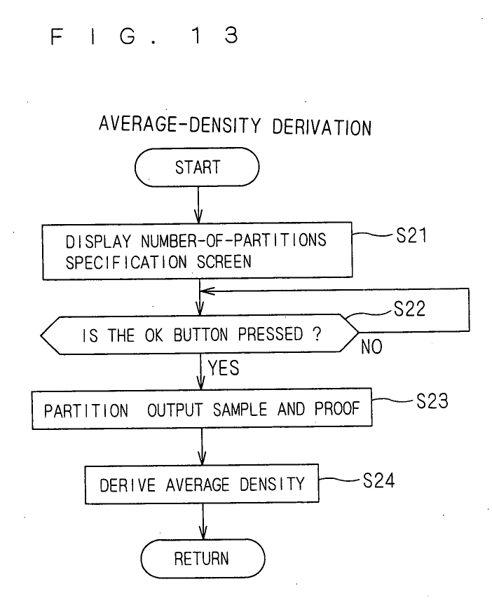

Now, the operation of the proofreading support system 1A will be described with reference to the flowcharts of FIGS. 11 to 14. FIG. 11 is a flowchart showing a flow of the overall operation of the proofreading support system 1A, and FIGS. 12 to 14 are flowcharts showing the operation flows of an output-sample and proof input subroutine (step S1), an average-density derivation subroutine (step S2), and an image comparison subroutine (step S4), respectively, in FIG. 11.

Overall Operation

As shown in FIG. 11, when the proofreading support system 1A starts to operate upon execution of the proofreading support program 232, firstly, the image input section 25 inputs the output sample 237 and the proof 238 and stores the output-sample data 233 and the proof data 234 in the hard disk drive (step S1).

Then, the average-density derivation section 26 partitions the output sample 237 and the proof 238 both longitudinally and laterally into the number of partitions specified by a user, and derives the average density for each block given by the partition from the output-sample data 233 and the proof data 234 stored in the hard disk drive 23 (step S2).

Then, the image comparison section 27 calculates the density distribution for each line in the output sample 237 and in the proof 238 (step S3), and performs image comparison processing for comparing the density distributions between the output sample 237 and the proof 238, and based on comparison results, outputting information about differences between the output sample 237 and the proof 238 as check results (step S4). To calculate the density distributions, as shown in FIGS. 4A to 4D, scale conversion is performed for both the output sample 237 and the proof 238, using the horizontal axis as a common index i. This allows image comparison even between the output sample 237 and the proof 238 of different sizes.

After step S4, the proofreading support system 1A refers to the check data 236 stored in the hard disk drive 23 to perform branch processing depending on the match or mismatch between the output sample 237 and the proof 238 (step S5). In step S5, if there is a match between the output sample 237 and the proof 238, i.e., if no difference is detected between the output sample 237 and the proof 238, the check-result output screen (match screen) 76 appears on the display 3 (step S6). On the other hand, in step S5, if there is a mismatch between the output sample 237 and the proof 238, i.e., if any difference is detected between the output sample 237 and the proof 238, the check-result output screen (mismatch screen) 75 appears on the display 3 (step S7). After completion of step S6 or S7, the flow of the overall operation of the proofreading support system 1A is completed.

This operation flow allows a user to find a match or mismatch between the output sample 237 and the proof 238, and also, in the case of mismatch, to find the location of mismatch.

Input of Output Sample and Proof

The output-sample and proof input subroutine is a subroutine to input the output-sample data 233 and the proof data 234 into the proofreading support system 1A.

In this subroutine, as shown in FIG. 12, firstly, the output-sample input screen 71 appears on the display 3 (step S11), and it is checked whether the OK button 711 has been pressed (step S12). In step S12, if the OK button 711 has been pressed, the operation flow proceeds to step S13 to read the output sample 237 placed on the document placement stage of the flatbed scanner 6. Or, in step S12, if the OK button 711 has not been pressed, the operation flow returns to step S12 to repeat a check for the press of the OK button 711.

After step S13, the proof input screen 72 appears on display 3 (step S14), and it is checked whether the OK button 724 has been pressed (step S15). In step S15, if the OK button 724 has been pressed, the operation flow proceeds to step S16 to perform branch processing depending on the selected radio button. Or, in step S15, if the OK button 724 has not been pressed, the operation flow returns to step S15 to repeat a check for the press of the OK button 724.

In step S16, if the radio button selected on the proof input screen 72 is the radio button 721 that indicates to read the proof 238, the proof 238 placed on the document placement stage of the flatbed scanner 6 is read (step S17). Or, if the radio button selected on the proof input screen 72 is the radio button 722 that indicates to read in the proof data 234, the proof data 234 is read in (step S18).

With completion of step S17 or S18, the output-sample and proof input subroutine is completed.

The operation flow of this subroutine allows the input of the output-sample data 233 and the proof data 234 into the proofreading support system 1A. Besides, the proof data 234 can be obtained either by reading a document with a scanner or by using existing image data.

Average-Density Derivation

The average-density derivation subroutine is a subroutine to derive the average densities to be the basis for image comparison.

In this subroutine, as shown in FIG. 13, firstly, the number-of-partitions specification screen 73 appears on the display 3 (step S21), and it is checked whether the OK button 733 has been pressed (step S22). In step S22, if the OK button 733 has been pressed, the average-density derivation section 26 partitions the output sample 237 and the proof 238 both longitudinally and laterally into the numbers of horizontal and vertical partitions, M and N, specified by a user on the number-of-partitions specification screen 73 (step S23), and derives the average density for each block given by the partition from the output-sample data 233 and the proof data 234 stored in the hard disk drive 23 (step S24). Or, in step S22, if the OK button 733 has not been pressed, the operation flow returns to step S22 to repeat a check for the press of the OK button 733.

With completion of step S24, the average-density derivation subroutine is completed.

The operation flow of this subroutine allows a user to partition the output sample 237 and the proof 238 into the specified number of partitions, M and N.

Image Comparison

The image comparison subroutine is a subroutine to output information for support of user-based proofreading.

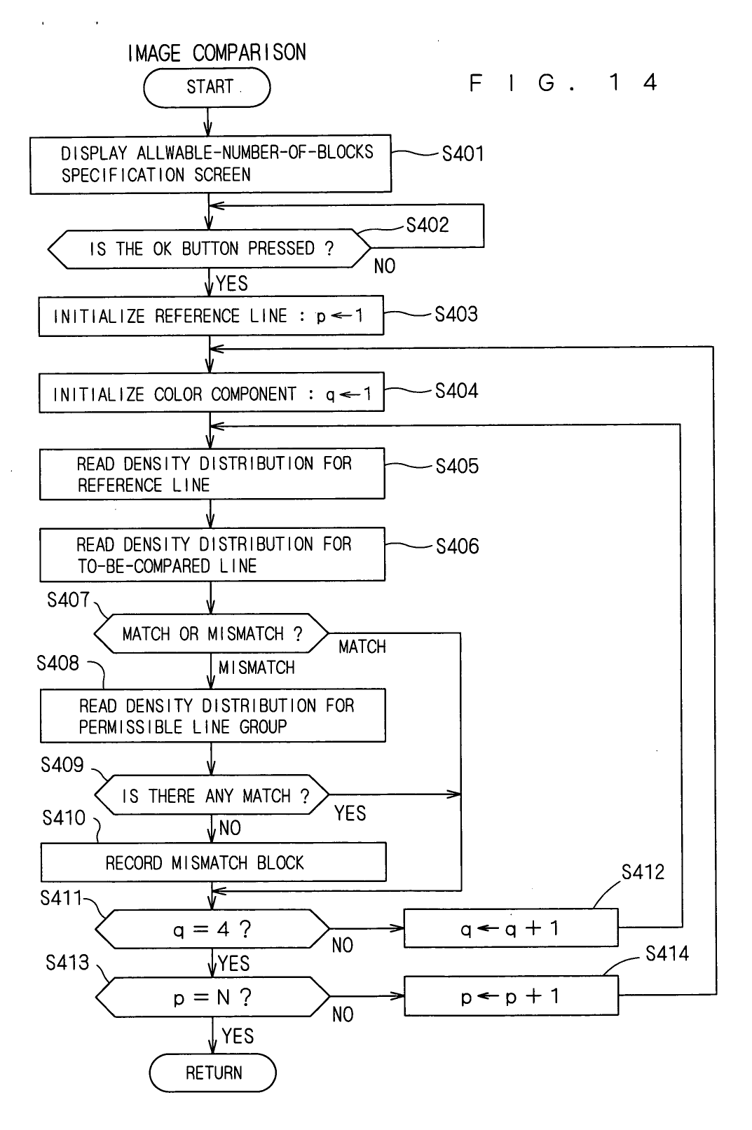

In this subroutine, as shown in FIG. 14, firstly, the allowable-number-of-blocks specification screen 74 appears on the display 3 (step S401), and it is checked whether the OK button 742 has been pressed (step S402). In step S402, if the OK button 742 has been pressed, the operation flow proceeds to step S403. Or, in step S402, if the OK button 742 has not been pressed, the operation flow returns to step S402 to repeat a check for the press of the OK button 742.

In step S403, the reference line LR for the line comparison is initialized (p is set to 1), and in the following step S404, the color component for the line comparison is initialized (q is set to 1). Here, the index p indicates the position of the reference line LR. For example, the index values p of 1, 2, and so on correspond to a first line, a second line, and so on, respectively, in the block array of the output sample 237. Further, the index q indicates the color component, and its values of 1, 2, 3, and 4 correspond respectively to the C, M, Y, and K color components.

Then, the density distribution for the color component q for the reference line LR at the position p is read in (step S405) and the density distribution for the color component q for the to-be-compared line LC at the same position p is read in (step S406) to make a comparison between those density distributions (step S407). In step S407, if there is a match in the density distributions, the operation flow proceeds to step S411, and if there is a mismatch in the density distributions, the operation flow proceeds to step S408.

In step S408, the density distribution for the color component q for each line within the permissible line group LP (except the to-be-compared line LC) is further read in, and in subsequent step S409, a comparison of the density distributions is made between the reference line LR and each line within the permissible line group LP (except the to-be-compared line LC). In step S409, if the permissible line group LP includes any line whose density distribution matches that for the reference line LR, the operation flow proceeds to step S411. Or, in step S409, if the permissible line group LP does not include any line whose density distribution matches that for the reference line LR, the operation flow proceeds to step S410, where a mismatch block having a mismatched density distribution is recorded in the check data 236, and then goes to step S411.

By execution of steps S409 and S410, even in the case where the density distributions do not actually match between the reference line LR and the to-be-compared line LC, only if the permissible line group LP includes any line whose density distribution matches that for the reference line LR, it is determined that there is a match in the density distributions between the reference line LR and the to-be-compared line LC.

Step S411 is a branch point depending on whether q=4, i.e., whether the line comparison has been completed for all the color components for a single reference line LR. If q≠4, the operation flow proceeds to step S412, where q is incremented by 1, and then returns to step S405. On the other hand, if q=4, the operation flow proceeds to step S413.

By execution of steps S405 to S412, in the case of any of the C, M, Y, and K color components, if the permissible line group LP does not include any line whose density distribution matches that for the reference line LR, a mismatch block is recorded in the check data 236.

Step S413 is a branch point depending on whether p=N, i.e., whether the line comparison has been completed for all the rows. If p≠N, the operation flow proceeds to step S414, where p is incremented by 1, and then goes to step S404. On the other hand, if p=N, this subroutine is completed.

In the operation flow of this subroutine, the line comparison is performed for all the color components for all the rows to record differences between the output sample 237 and the proof 238 as the check data 235. As an alternative, it is of course possible to perform the line comparison for all the columns.

### Second Preferred Embodiment

A proofreading support system 1B according to a second preferred embodiment of the present invention is similar in structure to the proofreading support system 1A according to the first preferred embodiment. Thus, the description with reference to FIGS. 1 and 2 is also applicable to the proofreading support system 1B. However, the proofreading support system 1B is different from the proofreading support system 1A, in that it has a different proofreading support program 232 stored in the hard disk drive 23 and uses a different line comparison technique.

The following is a description of this proofreading support system 1B, in which components and operations similar to those of the proofreading support system 1A are not described in order to avoid needless duplication, and differences from the proofreading support system 1A are mainly described. In the following description, components similar to those in the first preferred embodiment are denoted by the same reference numerals.

Line Comparison in Image Comparison Section

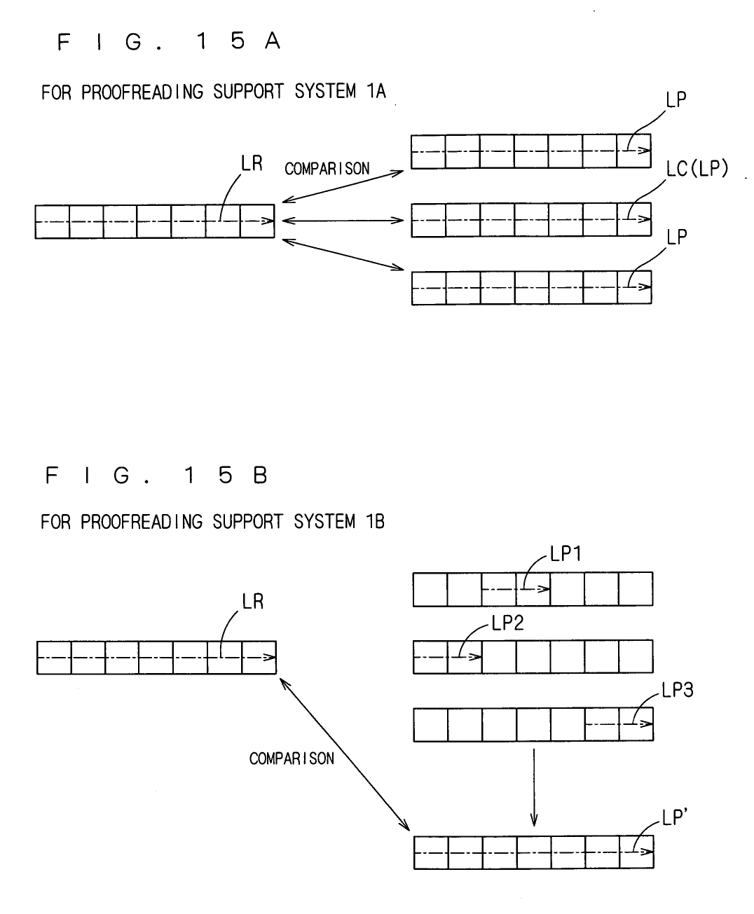

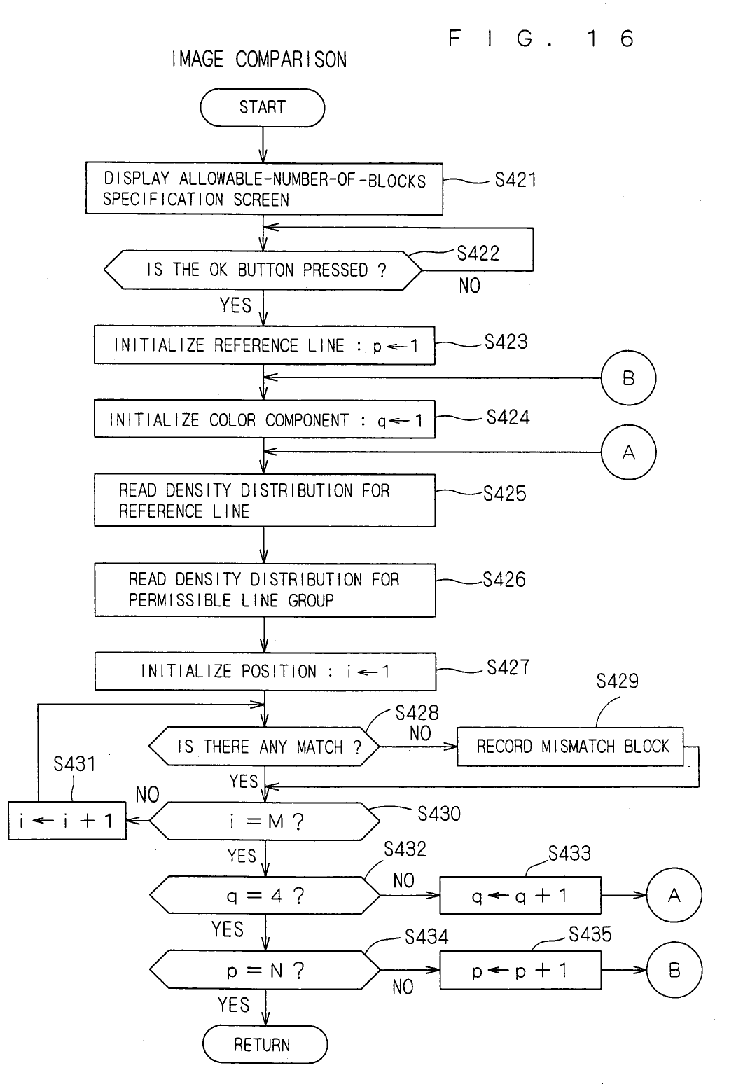

FIGS. 15A and 15B are diagrams for explaining differences of the line comparison between the proofreading support systems 1A and 1B.

As shown in FIG. 15A, the proofreading support system 1A makes comparison of the density distributions between the reference line LR and each line within the permissible line group LP. However, as shown in FIG. 15B, the proofreading support system 1B makes comparison of the density distributions between the reference line LR and a line LP′ which is generated by connecting pieces LP1 to LP3 of each line within the permissible line group LP. More specifically, in the proofreading support system 1B, if it is possible to generate such a line LP′ that has a similar density distribution to the reference line LR by connecting the pieces LP1 to LP3 of each line within the permissible line group LP, the image comparison section 27 determines that there is a match in the density distributions between the reference line LR and the to-be-compared line LC even if the reference line LR and the to-be-compared line LC do not have similar density distributions. Such a way of comparing the density distributions allows the output of appropriate information about major differences between the output sample 237 and the proof 238, even in the case where the reference line LR includes a plurality of parts which, when compared between the output sample 237 and the proof 238, deviate differently with respect to a direction perpendicular to the direction of extension of the reference line LR.

To implement such line comparison, the image comparison subroutine in the proofreading support system 1B has a different operation flow. This is described in the following.

Image Comparison

FIG. 16 is a flowchart showing the image comparison subroutine in the proofreading support system 1B.

Steps S421 to S424 in FIG. 16 correspond respectively to steps S401 to S404 in FIG. 14 and thus will not be described here to avoid needless duplication.

Subsequent to step S424, the density distribution for the color component q for the reference line LR at the position p is read in (step S425), and the density distribution for the color component q for each line within the permissible line group LP is read in (step S426).

Then, the index i that indicates a block position in the direction of line extension is initialized (step S427), and comparison of the average densities is made between a block at the position i on the reference line LR and a block at the position i on each line within the permissible line group LP (step S428). In step S428, if any one of the blocks at the position i on the respective lines within the permissible line group LP has the same average density with the block at the position i on the reference line LR, the operation flow proceeds to step S430. If not, the operation flow proceeds to step S429, where the block at the position i is recorded in the check data 236 as a mismatch block having a different density distribution, and the operation flow goes to the step S430.

Step S430 is a branch point depending on whether i=M, i.e., whether comparison for a single reference line LR has been completed. If i=M, the operation flow proceeds to step S432. If i=M, the operation flow proceeds to step S431, where i is incremented by 1, and returns to step S428.

Steps S432 to S435 in FIG. 16 correspond respectively to steps S411 to S414 in FIG. 14 and thus will not be described here to avoid needless duplication.

The operation flow of this image comparison subroutine allows implementation of the line comparison as shown in FIG. 15B.

While the invention has been shown and described in detail, the foregoing description is in all aspects illustrative and not restrictive. It is therefore understood that numerous modifications and variations can be devised without departing from the scope of the invention.

What is claimed is:

1. An image processing apparatus for outputting information about differences between a reference image and a to-be-compared image,
said image processing apparatus comprising:
an average-density derivation section for partitioning said reference image and said to-be-compared image into the same number of partitions both longitudinally and laterally and deriving average densities for respective blocks obtained by the partition from reference image data for said reference image and to-be-compared image data for said to-be-compared image data; and
an image comparison section for comparing distributions of said average densities within an image between said reference image and said to-be-compared image, and based on comparison results, outputting information about differences between said reference image and said to-be-compared image.

2. The image processing apparatus according to claim 1, wherein
said number of partitions is user-definable.

3. The image processing apparatus according to claim 1, wherein
said image comparison section is capable of making a line comparison of the distributions of said average densities in a direction of line extension between a reference line and a permissible line group,
said reference line being included in a block array of said reference image, said permissible line group being included in a block array of said to-be-compared image and including a to-be-compared line located in the same position as said reference line,
said line comparison being performed for all lines in said reference image to output, on the basis of results of said line comparison for all lines, information about differences between said reference image and said to-be-compared image.

4. The image processing apparatus according to claim 3, wherein
said permissible line group is a group of lines whose distances from said to-be-compared line are within an allowable number of blocks specified by a user.

5. The image processing apparatus according to claim 1, wherein
if there is a similarity in the distributions of said average densities in a direction of line extension between said reference line and any line within said permissible line group, said image comparison section determines that there is a match in the distributions of said average densities in the direction of line extension between said reference line and said to-be-compared line.

6. The image processing apparatus according to claim 1, wherein
if there is a similarity in the distributions of said average densities in a direction of line extension between said reference line and a line which is generated by connecting pieces of respective lines within said permissible line group, said image comparison section determines that there is a match in the distributions of said average densities in the direction of line extension between said reference line and said to-be-compared line.

7. The image processing apparatus according to claim 1, further comprising:
an image input section for reading an image to generate image data for said image,
said image input section generating at least either said reference image data or said to-be-compared image data.

8. The image processing apparatus according to claim 3, wherein
said reference line and said permissible line group in the direction of line extension are converted to a common scale.

9. An image processing program, readable by a computer, for outputting information about differences between a reference image and a to-be-compared image,
said image processing program causing said computer to perform the following procedures:
an average-density derivation procedure for partitioning said reference image and said to-be-compared image into the same number of partitions both longitudinally and laterally and deriving average densities for respective blocks obtained by the partition from reference image data for said reference image and to-be-compared image data for said to-be-compared image; and
an image comparison procedure for comparing distributions of said average densities within an image between said reference image and said to-be-compared image, and based on comparison results, outputting information about differences between said reference image and said to-be-compared image.
